(19) United States
(12) Patent Application Publication
(10) Pub. No.: US 2023/0294113 A1
(43) Pub. Date: Sep. 21, 2023

(54) CENTRIFUGE AND ROTOR USED IN SAME

(71) Applicant: Eppendorf Himac Technologies Co., Ltd., Ibaraki (JP)

(72) Inventors: Ryo Sato, Ibaraki (JP); Masayuki Shiina, Ibaraki (JP); Hidetaka Osawa, Ibaraki (JP); Ken Asakura, Ibaraki (JP); Hiroshi Hayasaka, Ibaraki (JP)

(73) Assignee: Eppendorf Himac Technologies Co., Ltd., Ibaraki (JP)

(21) Appl. No.: 18/022,979

(22) PCT Filed: Jun. 29, 2021
(86) PCT No.: PCT/JP2021/024635

§ 371 Date: Feb. 23, 2023

(30) Foreign Application Priority Data
Sep. 29, 2020 (JP) 2020-163243

(51) Int. Cl. B04B 15/06; B04B 5/04; B04B 13/00

(52) U.S. Cl. CPC B04B 15/06; B04B 5/0414; B04B 13/00

(57) ABSTRACT

A washing liquid distribution element attached to an upper portion of a rotor body includes an upper distribution element and a lower distribution element. A washing liquid is supplied from a washing liquid introduction port during rotation of a rotor and enters a recessed inner portion of the lower distribution element. The washing liquid entered in the inner portion moves from the vicinity of rotation center toward a radially outer side to climb an inclined part by centrifugal force. Washing liquid passages are formed in a radial pattern at a lower annular part at a tip of the inclined part, and the washing liquid is discharged radially outward from discharge ports of the washing liquid passages. Formation of the inclined part makes it possible to evenly distribute the washing liquid into test tubes.

### TECHNICAL FIELD

The present invention relates to a centrifuge that automatically performs washing of living cells such as red blood cells using centrifugal force, and in particular, to a centrifuge having a significant washing effect and suitable for improving washing reliability, and a rotor used therein.

### RELATED ART

Conventionally, cell washing centrifuges (blood cell washing centrifuges) are commercially available for washing red blood cells with a washing liquid such as saline to remove excess antibodies or the like in a suspension in antiglobulin tests, cross-matching tests, irregular antibody screenings, etc. at the time of blood transfusion tests. For example, the technique of Patent Document 1 is known as such a cell washing centrifuge. A known cell washing centrifuge such as that shown in Patent Document 1 includes a motor having a drive shaft, a rotor connected to the drive shaft of the motor and rotated by the motor, a plurality of test tube holders turnably mounted in a circular array onto the rotor and turning in an outer horizontal direction of the circular array by centrifugal force generated by rotation of the rotor, a washing liquid distribution element (distributor) mounted to the rotor, rotating simultaneously with the rotor, and supplying a washing liquid into a plurality of test tubes respectively held by the plurality of test tube holders, and a magnetic element (holding means) attracting the test tube holders at a vertical angle or at an angle close to the vertical angle by a magnetic attraction force generated based on energization to a magnetic coil.

In the cell washing centrifuge, a washing process including a washing liquid (saline) injection process, a centrifugation process, a supernatant discharge process, and an agitation process is automatically executed in sequence. Specifically, in the supernatant discharge process, the test tube holder is attracted by a magnetic device, the rotor is rotated while the test tube is held in a substantially vertical direction, and the supernatant in the test tube is discharged by centrifugal force. The washing liquid distribution element in Patent Document 1 has nozzles (washing liquid introduction ports) arranged in a radial pattern from a bottom surface outer periphery of a container with an inner surface being in a conical shape, and the washing liquid supplied to the washing liquid distribution element which rotates together with the rotor is ejected from the nozzles by centrifugal force to simultaneously supply the washing liquid into a large number of test tubes.

(A) of FIG. 10 is a vertical cross-sectional view showing a structure of a rotor 130 for cell washing of a conventional centrifuge. In the cell washing centrifuge, the rotor 130 includes a rotor body 31 having test tube holders 36 attached to an outer peripheral side, and a washing liquid distribution element 150 attached to an upper part of the rotor body 31. As the rotor 130 rotates, the washing liquid distribution element 150 attached to the upper surface of the rotor body 31 also rotates, and the washing liquid is supplied into an internal space 155 from a washing liquid introduction port 154 of the washing liquid distribution element 150 during rotation. In the washing liquid distribution element 150, the washing liquid introduction port 154 is formed at an upper distribution element 151, and a lower part of the washing liquid introduction port 154 has a conical inner wall 151a. On the other hand, a lower distribution element 161 fixed to oppose to the upper distribution element 151 has a conical surface 162 formed in a mountain shape. By forming an inclination of the inner wall 151a to be larger than that of the conical surface 162, a space between the upper distribution element 151 and the lower distribution element 161 forms an internal space 155 through which the washing liquid introduced from the washing liquid introduction port 154 passes. The internal space 155 spreads in an umbrella shape, and grooves 167 serving as passages for the washing liquid are formed in a radial pattern from the vicinity of an outer edge toward the radially outer side.

(B) of FIG. 10 is a perspective view showing a shape of the lower distribution element 161 of (A) of FIG. 10. The lower distribution element 161 includes a conical surface 162 formed in a mountain shape, a washing liquid receiving part 163 in a substantially annular shape connected from an outer edge of the conical surface 162 toward the radially outer side, and a lower annular part 164 arranged around the washing liquid receiving part 163. Flat contact surfaces 164a contacting the upper distribution element 151 are formed at an upper surface of the lower annular part 164. An upper side of the conical surface 162 forms a space in which the liquid moves toward the radially outer side. The washing liquid receiving part 163 in an annular shape is connected to the radially outer side of the conical surface 162, and the grooves 167 are connected to be narrowed from the washing liquid receiving part 163 into a spire shape. In the vicinity of a radially outer edge of the lower distribution element 161, a plurality of protruding parts 166 (e.g., 24 protruding parts 166) protruding toward the radially outer side are formed at equal intervals in the circumferential direction. The groove 167 is arranged at a circumferential center of the protruding part 166, and an outer tip of the groove 167 serves as an injection port 167b for injecting the washing liquid into the test tube 80. The plurality of contact surfaces 164a are respectively provided with screw holes 168 formed with female threads. A cylindrical part 169 is formed lower than the lower annular part 164 of the lower distribution element 161.

### RELATED ART DOCUMENTS

### Patent Documents

Patent Document 1: Japanese Patent Application Laid-Open No. 2009-2777

### SUMMARY OF INVENTION

### Problems to be Solved by Invention

In the conventional rotor 130 shown in FIG. 10, the washing liquid supplied to the internal space 155 of the washing liquid distribution element 150 during rotation descends the slope of the conical surface 162 by gravity while receiving centrifugal force, passes through the annular washing liquid receiving part 163 formed in the vicinity of the bottom surface of the conical surface 162, and is injected into each test tube 80 from the nozzle portion through the grooves 167 serving as washing liquid passages arranged in a radial pattern from inlets 167a on an outer periphery of the washing liquid receiving part 163. In a cell washing centrifuge using the washing liquid distribution element 150 described above, there are no problems arising from variations in the distribution amount to each test tube as the washing liquid is intentionally overflowed from the test tubes, but it is desirable that distribution accuracy of the washing liquid distribution element could be improved. In particular, it is necessary to adjust the liquid amount in the test tube at the end of the cell washing process, and as a method, the rotor is rotated while the test tube is held at an angle close to the vertical angle to discharge excess supernatant by centrifugal force. This discharge procedure requires complicated control by the motor, and it is difficult to improve the accuracy of the remaining amount in the test tube better than the current situation simply by rotation control of the motor.

The present invention has been made in view of the above background, and an objective of the present invention is to provide a centrifuge and a rotor used therein capable of improving distribution accuracy of a washing liquid using a washing liquid distribution element and evenly distributing the washing liquid to test tubes. Another objective of the present invention is to provide a centrifuge and a rotor used therein in which distribution accuracy of a washing liquid is improved by simply changing a shape of a washing liquid distribution element without changing rotation control of a motor for a conventional centrifuge or a configuration on a rotor body side.

### Means for Solving Problems

Representative features of the invention disclosed in the present application will be described below. According to the features of the present invention, a centrifuge of the present invention includes a motor, a rotor body, a plurality of test tube holders, a washing liquid distribution element, and a control device. The motor has a drive shaft. The rotor body is connected to the drive shaft of the motor and is rotated by the motor. The plurality of test tube holders are mounted in a circular array to an outer peripheral side of the rotor body and are supported to be capable of turning in an outer horizontal direction of the circular array by centrifugal force. The washing liquid distribution element is mounted to the rotor body and supplies a washing liquid into a plurality of test tubes respectively held by the plurality of test tube holders by discharging the washing liquid in a radial direction from a rotation center toward an outer periphery. The control device controls the motor. The washing liquid distribution element includes an upper distribution element and a lower distribution element. The upper distribution element includes a washing liquid introduction part having a washing liquid introduction port at a center, and an upper annular part continuous at a periphery of the washing liquid introduction part. The lower distribution element includes a concave part recessed in a direction away from a side on which the upper distribution element is positioned, and a lower annular part arranged at a position on a radially outer side of the concave part and opposed to the upper annular part. A plurality of grooves in a radial pattern are formed in one of a lower surface of the upper annular part and an upper surface of the lower annular part, and flow paths through which the washing liquid is discharged from the washing liquid distribution element are formed by joining the grooves to the opposing annular part. An inclined part that rises as it goes from a central axis of rotation toward the radially outer side is formed at an outer peripheral portion of the concave part of the lower distribution element, and the washing liquid supplied during rotation of the rotor climbs (rises) through the inclined part of the concave part by centrifugal force and flows into the flow paths.

According to other features of the present invention, the concave part includes the inclined part and an axial center part formed on an inner side of the inclined part. The inclined part occupies half or more of the concave part in the radial direction. The axial center part is formed of a flat surface, a curved surface, or a gentle surface having an inclination different from that of the inclined part. The washing liquid introduction part includes a neck part connected to an inner peripheral edge part of the upper annular part, and an annular part protruding from an upper edge part of the neck part toward one or both of a radially inner side and a radially outer side. The washing liquid introduction port is formed by the annular part. Further, the washing liquid introduction port is positioned higher than a dividing plane between the upper distribution element and the lower distribution element. The axial center part is positioned lower than the dividing plane between the upper distribution element and the lower distribution element. Herein, a flange part is formed at an outer peripheral part of the washing liquid introduction port, and a diameter of the flange part may be 80 mm or less.

According to yet other features of the present invention, the flow paths formed by joining the upper distribution element and the lower distribution element are arranged at equal intervals in a circumferential direction, and the lower surface of the upper distribution element and the lower surface of the lower distribution element are in close contact with each other at a portion other than the grooves when viewed in the circumferential direction to thereby prevent passing of the washing liquid. Screw parts are provided at each of the surfaces in close contact in the upper distribution element and the lower distribution element, and the upper distribution element and the lower distribution element are fixed by screws. Further, a width (length in circumferential direction) of the groove serving as the flow path is formed to be wide on an inner peripheral edge side of the lower distribution element, and have a width of the flow path that becomes narrow as it goes toward the radially outer side, and thus a cross section of the flow path narrows. A slope shape of the inclined part has a vertical cross-sectional shape that is a straight line shape, and is formed to have an inclination of 10 degrees to 45 degrees with respect to a horizontal plane, and more preferably 25 degrees to 35 degrees with respect to a horizontal plane. Further, a vertical cross-sectional shape of the inclined part may be configured in an arcuate shape protruding upward or downward. The washing liquid distribution element is detachably fixed to the body portion of the rotor by screws. An inner diameter of the annular part may be 60 mm or more and 80 mm or less so that the outer diameter of the flange part can be easily gripped by one hand.

### Effect of Invention

According to the above-described configuration of the present invention, the washing liquid supplied to the internal space of the washing liquid distribution element is injected into the space (lower space) defined by the concave part, and inside the concave part, the washing liquid uniformly rises on the slope due to centrifugal force, reaches the entrance of the grooves for distribution, and is ejected through the grooves into the test tubes. Therefore, the same amount of washing liquid can be supplied to a large number of test tubes at the same time with high accuracy. Further, depending on the type of pump that sends the washing liquid, pulsatile flow may occur and the flow rate may vary slightly. However, by adopting the structure of the present invention, regardless of whether the washing liquid is supplied continuously or intermittently, the washing liquid can be evenly distributed to the test tubes.

### BRIEF DESCRIPTION OF DRAWINGS

FIG. 1 is a vertical cross-sectional view showing an overall configuration of a centrifuge 1 according to the present invention.

FIG. 2 is a vertical cross-sectional view of a rotor 30 in FIG. 1.

FIG. 3 is an exploded perspective view of a washing liquid distribution element 50 in FIG. 2.

FIG. 4 is a partial vertical cross-sectional view of a rotor body 31 in FIG. 1, (A) of FIG. 4 is a state in which swing of a test tube holder 36 is restricted, and (B) of FIG. 4 is a state in which swing of the test tube holder 36 is permitted and swing is performed in a direction of an arrow 37.

(A) of FIG. 5 is a partial top view of the test tube holder 36 mounted with a test tube 80, and (B) of FIG. 5 is a partial side view of the test tube holder 36 mounted with the test tube 80 (stationary state).

FIG. 6 is a time chart showing an example of rotational speed control of the rotor 30 in a washing cycle.

FIG. 7 is a diagram showing processes and states of the test tube 80 in the washing cycle.

FIG. 8 is a vertical cross-sectional view showing a detailed shape of the washing liquid distribution element 50 in FIG. 1.

(A) of FIG. 9 is a cross-sectional view showing flow of a washing liquid in the washing liquid distribution element 50, and (B) and (C) of FIG. 9 are cross-sectional views of the washing liquid distribution element according to a first medication example and a second modification example.

(A) of FIG. 10 is a vertical cross-sectional view showing a rotor 130 for cell washing of a conventional centrifuge, and (B) of FIG. 10 is a perspective view showing a lower distribution element 161.

### DESCRIPTION OF EMBODIMENTS

Embodiments of the present invention will be described in detail with reference to the drawings. In all the drawings for illustrating the embodiments, members having the same function will be labeled with the same reference sign, and repeated descriptions thereof will be omitted. The terms “parallel”, “perpendicular”, etc. in this specification also cover states including machining tolerances, assembly tolerances, etc.

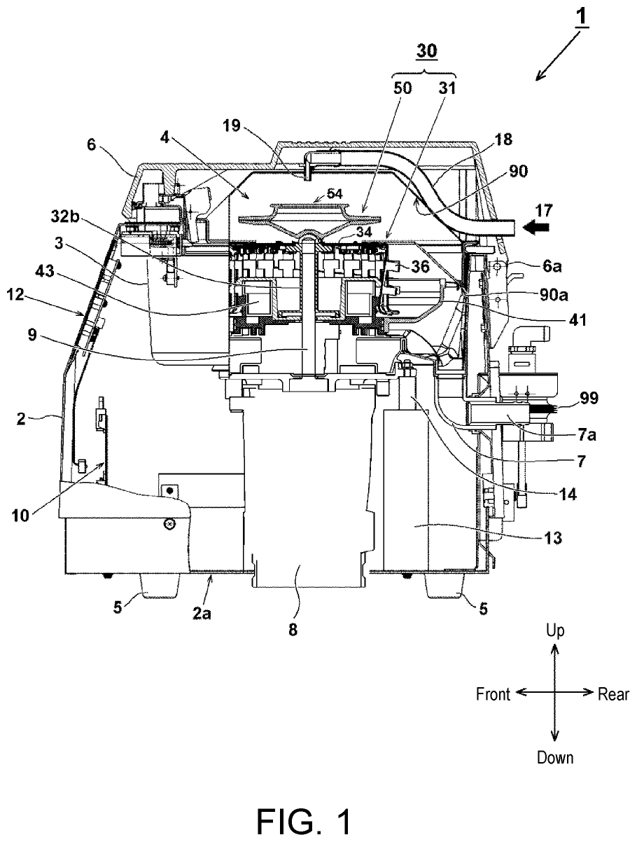

FIG. 1 is a vertical cross-sectional view showing an overall configuration of a centrifuge 1 according to the present invention. The centrifuge (cell washing centrifuge) 1 for cell washing includes a housing (frame) 2 having a rectangular cross-sectional shape when viewed from above, a door 6 opening and closing an upper part of the housing 2, and a chamber 3 arranged inside the housing 2, and the centrifuge 1 rotates a rotor 30 inside the chamber 3 (in a rotor chamber 4). The housing 2 includes a plurality of legs 5 and is installed on a floor or the like. The door 6 is of an opening/closing type in which a front side is swingable in the up-down direction around a hinge 6a provided on a rear side. A motor 8 is arranged at a base part 2a of the housing 2, and a drive shaft 9 of the motor 8 extends to an internal space of the rotor chamber 4 through a through hole at a bottom part of the chamber 3. The motor 8 is attached to a post (made of metal) 13 via a rubber damper 14 for reducing vibration, and the post 13 is fixed to the base part 2a of the housing 2. The rotor 30 is mounted at an upper end of the drive shaft 9. The motor 8 is, for example, a brushless DC motor. Rotation of the motor 8 is driven by an inverter circuit (not shown), and the number of revolutions (rotational speed) of the motor 8 is controlled by a control device 10. An operation display panel 12 (such as a touch-type liquid crystal display) is provided at a front side surface of the housing 2. The operation display panel 12 serves as a means for inputting information from a user and a means for displaying information from the control device 10.

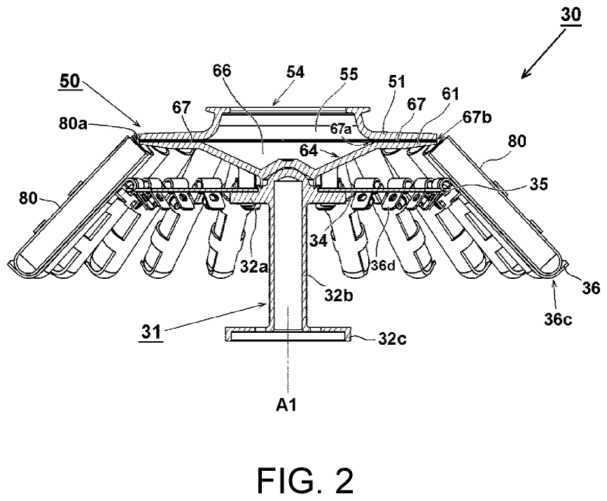

The rotor 30 is a dedicated centrifuge rotor for performing cell washing and includes a plurality of test tube holders 36 (herein, 24 test tube holders 36) arranged side by side at equal intervals in the circumferential direction when viewed from above. With an inner peripheral side surface of the test tube holder 36 being pivotally supported by a circular holding part 34 of the rotor 30, the test tube holder 36 is held in a manner capable of swinging (turning) in the centrifugal direction (radial direction). The test tube holder 36 is made of a magnetic member, and a test tube 80 (see FIG. 2) is inserted downward from above. A sample (liquid) containing living cells such as red blood cells is placed inside each test tube 80 (not shown) in advance, and the test tubes 80 containing the sample are manually set by the user into the respective test tube holders 36 before start of a centrifugation operation.

The rotor 30 includes a holding means 43 for holding a longitudinal central axis of the test tube holder 36 at a vertical or near-vertical small swing angle. Rotating integrally with the rotor 30, the holding means 43 maintains a non-swingable state of the test tube 80 by attracting the metal test tube holder 36 with magnetic force. Using a magnetic element based on an electromagnet, the holding means 43 can electrically switch between an attraction state (fixed state or non-swingable state) and a release state (swingable state) of the test tube holder 36 under control of the control device 10. When the test tube holder 36 is in the attraction state, the rotor 30 functions as a so-called angle rotor having a negative swing angle, and when the test tube holder 36 is in the release state, the rotor 30 functions as an angle rotor having a positive swing angle. A swing angle θ₁ of the test tube in the release state is approximately 40°.

The rotor 30 for cell washing is detachable from the drive shaft 9. Therefore, the drive shaft 9 may also be mounted with a normal angle rotor or swing rotor that cannot supply washing liquid during rotation. The rotor 30 for cell washing is attached with a washing liquid distribution element 50 at an upper part of a rotor body 31 holding the plurality of test tubes 80, and supplies a liquid such as a washing liquid into the test tubes 80 during rotation (swinging) of the rotor 30 using a washing liquid supply pipe 18 provided inside the door 6. The washing liquid distribution element 50 is fixed to the rotor body 31 by a plurality of screws and rotates integrally with the rotor body 31 on which the test tube holders 36 in a circular array are mounted.

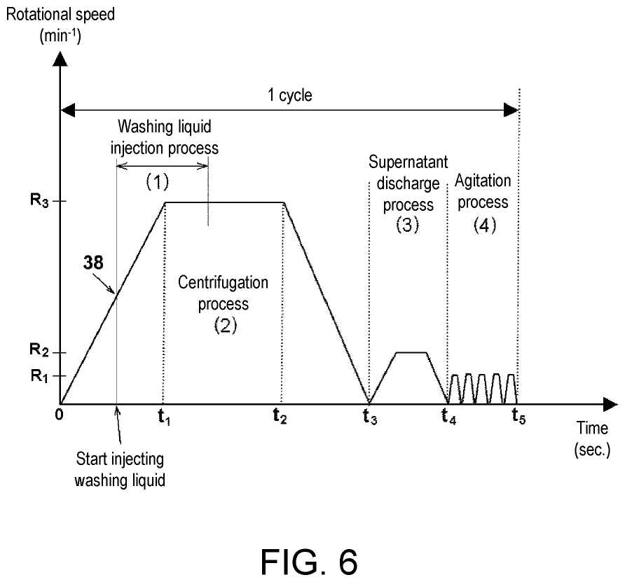

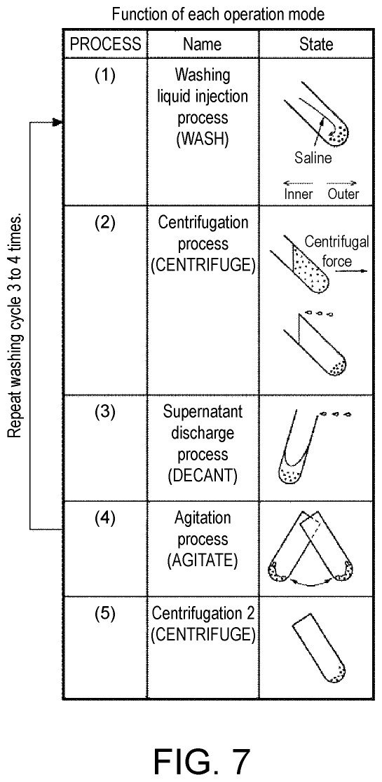

A pump (not shown) is connected to an outer end of the washing liquid supply pipe 18 which supplies the washing liquid to the washing liquid distribution element 50. By turning on the operation of a pump 99 by the control device 10, a washing liquid 17 is sucked out from an external washing liquid tank (not shown) and is discharged from a nozzle 19 positioned at the upper part of the centrifuge 1 through the washing liquid supply pipe 18. In a “washing liquid injection process” to be described later with reference to FIG. 6 and FIG. 7, the washing liquid discharged from the nozzle 19 to the washing liquid distribution element 50 is introduced into an internal space of the washing liquid distribution element 50 from a washing liquid introduction port 54 at a center of the washing liquid distribution element 50 which rotates at high speed integrally with the rotor body 31.

A bowl-shaped bottom surface part 41 is formed at a lower part of the rotor body 31. The bottom surface part 41 is a member that serves as a stopper for restricting the swing angle of the test tube holder 36. The test tube holder 36 turns in the radially horizontal direction of the circumference of the rotor body 31, and a lower part (holding bottom part 36c to be described later with reference to FIG. 2) of the test tube holder 36 is tilted until contacting a wall surface of the bottom surface part 41. In this contacted state, the sample such as blood cells in the test tube 80 is centrifuged.

Since the washing liquid is injected while the rotor 30 is rotating and excess washing liquid is discharged from the inside of the test tube 80, the spilled washing liquid may accumulate on the bottom surface part of the chamber 3. Therefore, a drain pipe 7 is connected to a part of the bottom surface of the chamber 3, and a discharge port 7a leading to the outside of the housing 2 is arranged at an end of the drain pipe 7. The user collects or disposes of the excess washing liquid (waste liquid) using a hose or the like at an end of the discharge port 7a. Most of the discharged washing liquid passes through a space of a washing liquid collection cover 90, drops downward from a discharge part 90a, flows into the drain pipe 7, and is discharged to a drain pipe (not shown) or the like via the discharge port 7a.

FIG. 2 is a vertical cross-sectional view of the rotor 30. FIG. 2 shows a state in which the test tubes 80 are mounted in the respective test tube holders 36 and are rotating at a predetermined number of revolutions or more (a state in which the test tubes 80 are swinging). Herein, illustration of the holding means 43 (see FIG. 1) included in the rotor 30 is omitted. The rotor body 31 includes a main shaft part 32b mounted to the drive shaft 9, a flange part 32a formed in a disk shape at an upper end of the main shaft part 32b, and an attachment part 32c formed at a lower end of the main shaft part 32b. The rotor body 31 may be made of metal or synthetic resin, and the flange part 32a and the circular holding part 34 may be manufactured by integral molding. The flange part 32a is a fixing portion for screwing the circular holding part 34 and the washing liquid distribution element 50.

The washing liquid distribution element 50 is composed of two members including an upper distribution element 51 and a lower distribution element 61. By joining the upper distribution element 51 and the lower distribution element 61, internal spaces (55, 66) and a plurality of grooves 67 serving as flow paths are formed. An upper part of the upper distribution element 51 is formed with the washing liquid introduction port 54 for receiving the washing liquid discharged from the nozzle 19 (see FIG. 1) arranged on a rotation axis A1. A plurality of grooves 67 in a radial pattern are formed at an upper surface of a lower annular part 62, and by joining the lower annular part 62 to an upper annular part 52 having a flat bottom surface, flow paths for the washing liquid are formed by the grooves 67. A radially outer peripheral end of the groove 67 opens as a discharge port 67b.

The test tube holder 36 is a member that holds the test tube 80 made of glass or synthetic resin so that the test tube 80 does not drop during stoppage and during centrifugal operation. Each test tube holder 36 is held at an outer peripheral edge of the circular holding part 34 in a swingable state by a turning shaft 35. When the test tube holder 36 swings in the state shown in FIG. 2, the position of an opening 80a of the test tube 80 moves, and the discharge port 67b comes close to above the opening 80a of the test tube 80. In the state shown in FIG. 2, the washing liquid is supplied from the washing liquid introduction port 54 to the internal spaces (55, 66), the washing liquid moves in the radial direction through the internal space 66 and the grooves 67 due to the centrifugal force, and the washing liquid is injected into the test tubes 80 from the discharge ports 67b. If the timing of supplying the washing liquid is set to a time when the rotational speed of the rotor 30 is equal to or higher than a predetermined number of rotations and, as shown in FIG. 2, the test tube holder 36 swings and the opening 80a of the test tube 80 approaches the discharge port 67b, the supplied washing liquid is supplied to the inside of the test tube 80 from the opening 80a without leaking out of the test tube 80. A stopper 36d formed at the test tube holder 36 is provided to prevent tilting toward the rotation axis A1 more than necessary when the rotor 30 is removed from the centrifuge 1.

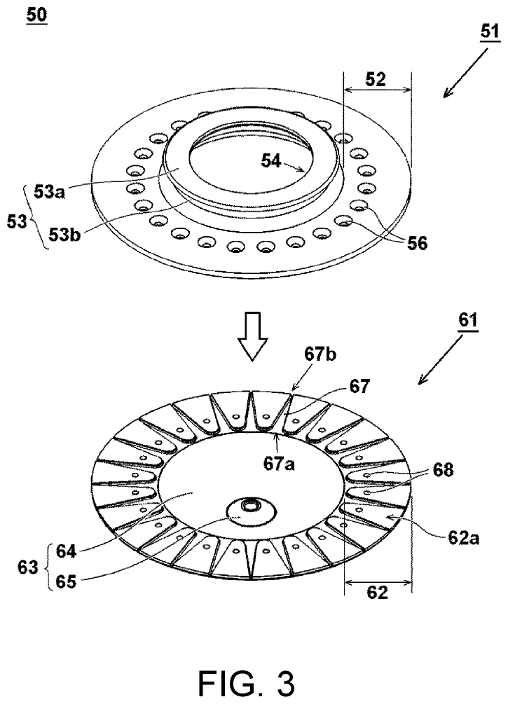

FIG. 3 is an exploded perspective view of the washing liquid distribution element 50. The washing liquid distribution element 50 is composed of two parts including the upper distribution element 51 and the lower distribution element 61. The upper distribution element 51 and the lower distribution element 61 are fixed by screwing screws (not shown) respectively into screw holes 56 and screw grooves 68 formed in a large number. The upper distribution element 51 is integrally manufactured by injection molding of synthetic resin, and includes a washing liquid introduction part 53 and an upper annular part 52 formed on the radially outer side of the washing liquid introduction part 53. The washing liquid introduction part 53 includes a neck part 53b and a flange part 53a connected to an upper end of the neck part 53b. The flange part 53a is an annular member extending radially outward and inward from the upper end of the neck part 53b, and an inner side of the flange part 53a forms the washing liquid introduction port 54. The diameter of the washing liquid introduction port 54 of the washing liquid distribution element 50 is formed relatively large in this embodiment, and the diameter (=outer diameter) of the flange part 53a is about 70 mm so that the user can grip an outer edge of the flange part 53a when gripping the rotor 30 as a whole. Further, the user may place three or four fingers of one hand inside the flange part 53a to grip the flange part 53a. In other words, the flange part 53b may be used as a part of a portion to be gripped not only on the outer side but also on the inner side. In the case where the washing liquid introduction port 54 is used as a gripping portion by the user in this manner, it is desirable to make the diameter (outer diameter) of the flange part 53a within a range of about 60 mm to 80 mm, which is a range easy for gripping with one hand.

24 screw holes 56 are formed at equal intervals in the circumferential direction in the upper annular part 52 of the upper distribution element 51. At the screw hole 56, the vicinity of the opening is formed in a conical shape so that a countersunk screw having a cross recess and a flat head with the head seat surface side cut off can be attached, and a female screw part is formed at a lower part of the conical portion. Screw parts of the countersunk screws (not shown) are screwed into the 24 screw grooves 68 formed on the lower distribution element 61 side. By using countersunk screws, head parts of the screw holes 56 can be configured to be substantially flush with the upper annular part 52. Although the shape of the lower surface of the upper annular part 52 cannot be seen in FIG. 3, the lower surface is formed as a flat horizontal surface except at the screw hole 56 portions, and is in close contact with flat surfaces (contact surface) 62a of the lower annular part 62.

The lower distribution element 61 is integrally manufactured by injection molding of synthetic resin, and a half portion or more in the radial direction from the rotation axis A1 is recessed downward to form a concave part 63. A mountain-shaped axial center part 65 is formed at the rotation axis A1 of the concave part 63. The axial center part 65 is a portion formed corresponding to the upper end of the rotor body 31 which protrudes in a hemispherical shape. The lower distribution element 61 is fixed to the rotor body 31 by screws (not shown) that are inserted from the lower side toward the upper side. The concave part 63 forms an internal space 66 (see FIG. 2 for the reference sign) of the lower distribution element 61. The concave part 63 is formed with a slope (inclined part 64) that rises as the distance from the rotation axis increases, and is formed with the lower annular part 62 on the radially outer side of the vicinity of an outer peripheral edge of the slope. A plurality of grooves 67 extending from the radially inner side toward the radially outer side are formed in the lower annular part 62, a flat surface 62a is provided between adjacent grooves 67, and a plurality of screw grooves 68 are formed substantially at centers of the flat surfaces 62a.

The washing liquid that has moved to the radially outer side through the inclined surface of the concave part 63 due to the centrifugal force during rotation of the rotor 30 reaches the vicinity of the boundary with the lower annular part 62 and flows into any of the grooves 67. The width of the groove 67 when viewed in the circumferential direction is formed in a tapered shape with an inner peripheral edge side of the lower distribution element being wide and a cross section of the flow path being narrowed as it goes radially outward, an inner peripheral side forms an inlet 67a, and an outer peripheral side end forms a discharge port 67b. Although the depth (width in the up-down direction) of the groove 67 is configured to be constant, the depth of the groove 67 may be arbitrary, and the groove 67 on the inner peripheral edge side may be made deeper, and the groove 67 may be made shallower toward the radially outer side so that the cross section of the flow path is further narrowed. Herein, for an equal amount of washing liquid to easily flow into the 24 grooves 67 arranged at equal intervals in the circumferential direction, a shape is configured to have an inlet side that has a predetermined width in the circumferential direction and a circumferential width that narrows as it goes radially outward, and the discharge port 67b is formed to have a small circumferential width so that the washing liquid can be accurately injected into the opening 80a of the test tube 80.

A region of the lower annular part 62 other than the portion where the groove 67 and the screw groove 68 are formed forms the flat surface 62a and is in close contact with the lower surface of the upper annular part 52. In this manner, both the upper distribution element 51 and the lower distribution element 61 are manufactured by integral molding of synthetic resin, and since the flow path through which the washing liquid is discharged forms a groove space by covering the groove 67 formed in the lower distribution element 61 and the upper surface of the groove 67, manufacturing is easy and a desired flow path shape can be realized. Although the washing liquid distribution element 50 shown in FIG. 3 is configured so that the grooves 67 are formed on the lower distribution element 61 side and closed by the lower surface (flat surface) of the upper distribution element 51, it may also be configured by reversing these relationships so that the grooves are formed on the upper distribution element 51 side and closed by the upper surface (flat surface) of the lower distribution element 61. Further, grooves may also be formed in both the upper distribution element 51 and the lower distribution element 61 to form the flow paths by matching the upper grooves with the lower grooves. Furthermore, the upper distribution element 51 and the lower distribution element 61 may be manufactured by integral molding without being configured as separate parts, or the upper distribution element 51 and the lower distribution element 61 may be realized in a multi-divided form instead of the two-divided form. Further, the groove (washing liquid passage) 67 may be formed to have a constant width (substantially constant cross-sectional area) on the radially outer side.

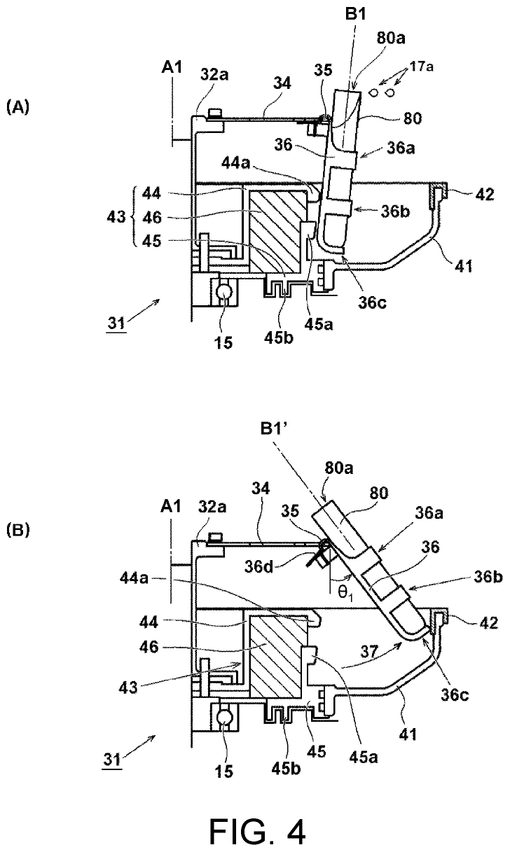

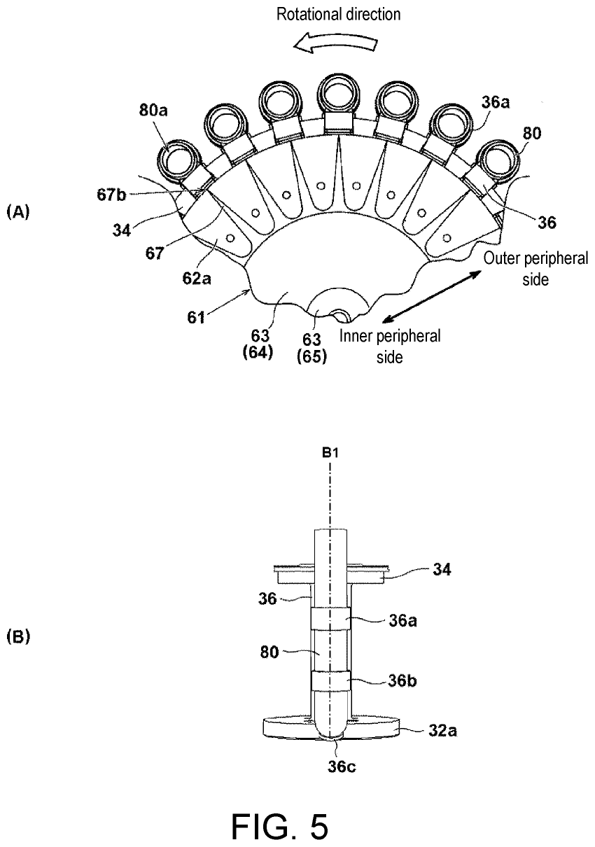

FIG. 4 is a partial vertical cross-sectional view of the rotor 30, (A) of FIG. 4 is a state in which swing of the test tube holder 36 is restricted by the holding means 43, and (B) of FIG. 4 is a state in which swing of the test tube holder 36 is permitted. Herein, different from FIG. 1, a state in which the test tube 80 is mounted to the test tube holder 36 is illustrated. Although (A) and (B) of FIG. 4 both show the state during rotation of the rotor 30, in the state shown in (A) of FIG. 4, since the attraction force (magnetic force) generated by the holding means 43 is stronger than the centrifugal force applied to the test tube holder 36, the test tube holder 36 remains in a substantially vertical state. On the other hand, in the state shown in (B) of FIG. 4, since the attraction force (magnetic force) generated by the holding means 43 is not present, the test tube holder 36 swings in the direction of an arrow (swing direction) 37 due to the centrifugal force.

The test tube holder 36 is made of a magnetic material, such as a stainless steel alloy made of SUS430 material and attracted by a magnet. Holding insertion parts 36a and 36b are formed midway in the longitudinal direction of the test tube holder 36, and a holding bottom part 36c that supports a bottom part of the test tube 80 is formed at a longitudinal lower end. The holding insertion parts 36a and 36b are portions formed by bending a part of a metal plate into a ring shape, and the holding bottom part 36c is a portion that holds the bottom part of the test tube 80 by bending a part of a metal plate cut out by press working toward the radially outer side. Each test tube holder 36 is held at the outer peripheral edge of the circular holding part 34 in a swingable state by the turning shaft 35. When an external force due to a centrifugal force is not applied to the test tube holder 36, the test tube holder 36 is stopped at a position in a direction of being attracted to the holding means 43 as shown in (A) of FIG. 4.

The holding means 43 includes a magnetic element (electromagnet) that generates magnetism by electric power. The holding means 43 includes an upper magnetic member 44 and a lower magnetic member 45 in disk shapes, and further includes a ring-shaped coil (magnetic coil) 46 of an insulated wire that is sandwiched between the upper magnetic member 44 and the lower magnetic member 45. Since the holding means 43 is fixed to the rotor 30, it rotates together with the rotor 30. Further, when the rotor 30 is removed from the drive shaft 9, the holding means 43 is also removed together. The wiring to the magnetic coil 46 of the holding means 43 is performed from a bottom surface side of the chamber 3 by means of a slip ring (not shown) and can supply current to the magnetic coil 46 not only during stoppage but also during rotation of the rotor 30. Since this wiring structure is conventionally known, descriptions thereof will be omitted herein. The on/off of current supply to the magnetic coil 46 is controlled by the control device 10 having a microcomputer. When the magnetic coil 46 is energized with current, a strong magnetic force can be generated through the upper magnetic member 44 and the lower magnetic member 45. Since the test tube holder 36 is made of a magnetic material, it forms a magnetic circuit together with the upper magnetic member 44 and the lower magnetic member 45.

The outer diameter of an attraction part 44a (a portion in contact with the test tube holder 36) of the upper magnetic member 44 is slightly larger than the outer diameter of an attraction part 45a (a portion in contact with the test tube holder 36) of the lower magnetic member 45. Therefore, the attraction parts 44a and 45a of the upper magnetic member 44 and the lower magnetic member 45 can hold the test tube holder 36 in a state in which the bottom part side of the test tube 80 is slightly tilted toward the inner side with respect to a vertical line (parallel to the rotor rotation axis A1), i.e., in a state in which the upper opening is slightly tilted toward the radially outer side (swing angle θ₁=approximately)−6°. A labyrinth part 45b is formed at a bottom surface of the lower magnetic member 45 to restrict the flow of air and water between a bearing 15 and the rotor chamber 4.

(B) of FIG. 4 is a state in which the rotor 30 is rotating at a high rotational speed, and in this state, the test tube holder 36 holding the test tube 80 swings around the turning shaft 35 in a direction (radial direction) of an arrow 37 due to the centrifugal force. A maximum value of the swing angle θ1 is restricted by the contact of the holding bottom part 36c of the test tube holder 36 with an outer peripheral part of the cup-shaped bottom surface part 41. In other words, an outer edge wall of the bottom surface part 41 functions as a stopper for the swing state of the test tube holder 36. This swing is performed when the ring-shaped coil 46 is not energized. When the test tube holder 36 swings greatly as shown in (B) of FIG. 2, the holding bottom part 36c of the test tube holder 36 contacts a stopper 42 (e.g., made of metal such as stainless steel) for strength reinforcement. Herein, the swing angle θ1 is about 40°, and centrifugal operation is performed in this state.

When the washing liquid injection process is performed using such a swingable rotor 30, the test tube holders 36 turn in an outer horizontal direction of the circular array due to the centrifugal force generated by rotation of the rotor 30. In the turning state as shown in (B) of FIG. 4, since the opening 80a of the test tube 80 is oriented toward the rotation axis A1, the washing liquid can be injected into the test tube 80 from the discharge port 67b (see FIG. 2) of the washing liquid distribution element 50. In a supernatant discharge process after the washing liquid injection process, as shown in (A) of FIG. 4, by fixing the test tube holder 36 in a substantially vertical state by the holding means 43 and rotating the rotor 30, excess supernatant 17a can be discharged from the test tube 80 to the outside.

(A) of FIG. 5 is a partial top view of the test tube holder 36 mounted with the test tube 80, and (B) of FIG. 5 is a partial side view of the test tube holder 36 mounted with the test tube 80, showing the rotor 30 during a stationary period or during rotation with the test tube holder 36 being prevented from swinging. As shown in (A) of FIG. 5, the plurality of test tube holders 36 are arranged side by side at equal intervals in the rotational direction. The test tubes 80 made of glass or synthetic resin are mounted into the respective test tube holders 36. In a state in which the test tube holder 36 is prevented from swinging, i.e., in a state in which the test tube holder 36 is attracted by the holding means 43, the opening 80a of the test tube 80 is in a state of being tilted slightly outward from the rotation axis A1 side of the rotor 30 and a vertical plane. On an inner peripheral side of the openings 80a of the test tubes 80, the washing liquid distribution element 50 is provided (only the lower side distribution element 61 is shown in the drawing), and passages are formed from the grooves 67, which are passages for the washing liquid, to the plurality of discharge ports 67b. The discharge ports 67b are arranged corresponding to the respective test tubes 80. The opening 80a of the test tube 80 is arranged at a distance from the discharge port 67b in the radial direction, and this is because the positional relationship has been configured such that the washing liquid discharged from the discharge port 67b during rotation of the rotor 30 is injected into the opening 80a of the test tube 80 by centrifugal force.

(B) of FIG. 5 is a side view of one test tube 80 and test tube holder 36. The test tube holder 36 fixes the bottom part of the held test tube 80 by the holding bottom part 36c so that the held test tube 80 does not come off during centrifugation operation. A ring-shaped holding insertion part 36a is formed slightly higher than a substantially axial center of the test tube 80, and a ring-shaped holding insertion part 36b is formed between the ring-shaped holding insertion part 36a and the holding bottom part 36c. The holding insertion parts 36a and 36b and the holding bottom part 36c are formed in one piece of magnetic metal. Herein, a center axis B1 is held to coincide with a vertical line direction along the rotation axis A1 of the rotor 30 when viewed from the lateral side.

Next, the procedure for executing a washing cycle will be described with reference to FIG. 6 and FIG. 7. FIG. 6 is a time chart showing an example of rotational speed control of the rotor 30 in the washing cycle. FIG. 7 is a diagram showing each process and the state of the test tube 80 in the washing cycle. First, from time 0 to time t₁, the motor 8 is started to accelerate the rotor 30 to a centrifugation rotational speed R₃. At this time, the test tube holder 36 is in a swingable state, i.e., in a state in which attraction of the test tube holder 36 by the holding means 43 (see FIG. 4) is not performed. When the swing amount of the test tube holder 36 reaches its maximum at the time point of an arrow 38 while the rotor 30 is accelerating, the washing liquid is dropped downward from the nozzle 19 and starts to be injected into the washing liquid distribution element 50 from the washing liquid introduction port 54. The washing liquid that has entered the inside of the washing liquid distribution element 50 passes through the grooves 67 and the discharge ports 67b and is supplied to the inside of each test tube 80 from the upper-side openings 80a of the test tubes 80 in the swung state. The acceleration period (period of (1)) for supplying the washing liquid is “(1) washing liquid injection process (WASH)” shown in FIG. 7, and is performed until a predetermined amount of washing liquid is supplied. Specifically, in “(1) washing liquid injection process (WASH)”, at the time point when the rotational speed of the rotor 30 reaches 1200 rpm, a specific amount of washing liquid (e.g., saline) is sent by the pump 99 (see FIG. 1) to the washing liquid distribution element (distributor) 50, and the washing liquid is supplied until the rotor 30 settles (constant speed operation) after time t₁ (liquid feeding may be completed before settling). The saline is vigorously injected from the washing liquid distribution element 50 into each test tube 80 by centrifugal force. At this time, the blood cells in the test tube 80 are sufficiently suspended in the saline.

When the injection of the washing liquid ends midway in the acceleration period and the rotational speed of the rotor 30 reaches the set rotational speed R₃ (e.g., 3000 rpm) of the centrifugation operation at time t₁, operation of a set time (centrifugation operation time=t₂−t₁) is performed. Herein, with the liquid surface being oriented toward the vertical direction as shown in the column of “(2) centrifugation process” in FIG. 7, excess washing liquid injected into the inside of the test tube 80 leaks out from the upper-side opening of the test tube 80. Further, the sample moves to the bottom part in the washing liquid. When time t₂ is reached in “(2) centrifugation process” in FIG. 6, the motor 8 is decelerated to stop the rotation of the rotor 30.

When the rotation of the rotor 30 stops at time t₃ in FIG. 6, “(3) supernatant discharge process” is performed. In this discharge process, by energizing the ring-shaped coil 46 of the holding means 43 (see FIG. 2), the test tube holder 36 is attracted. The state of the test tube 80 at this time is as shown in “(3) supernatant discharge process (DECANT)” in FIG. 7, in which the opening 80a is tilted slightly outward so that the swing angle is slightly negative, and in this state, the rotor 30 is accelerated to a settling speed R₂, settles for a specific time, and the rotor 30 is decelerated. By rotating the rotor 30 with the swing angle of the test tube 80 being in a slightly negative state in this manner, the supernatant rises on the wall surface of the test tube 80 due to the centrifugal force and is discharged to the outside, and as a result, most of the supernatant is discharged to outside of the test tube 80.

When the rotor 30 stops at time t₄, “(4) agitation process” is executed next. “(4) agitation process” is a process (AGITATE) of agitating the test tube holder multiple times in a short period of time to stir the remaining washing liquid and sample. Herein, the rotational speed of the rotor 30 is accelerated to R₁, settles for a short period of time, and then immediately decelerated, and this operation of repeating rotation and stop in small increments of acceleration, settling, and stop is performed multiple times (herein, 5 times). The washing cycle described above from (1) to (4) is repeated multiple times, e.g., about 3 to 4 times, and after “(4) agitation process” of the final washing cycle, additional “(5) centrifugation process (“centrifugation 2”)” is performed to end the cycle. In the process of (5), the rotor 30 is rotated for several seconds.

As described above, in this embodiment, the concave part 63 for accumulating the washing liquid injected into the lower distribution element 61 is formed, and a portion of the concave part 63 connected to the grooves 67 on the outer peripheral part in particular is formed as a slope that rises from the inner side toward the outer side. Therefore, with the centrifugal force, the washing liquid climbs the slope and is supplied to the outer peripheral side of the concave part 63, is branched into flow paths (grooves 67) in the same number (24) as the test tubes 80 held by the test tube holders 36, and is vigorously injected into each test tube 80 from the discharge ports 67b of the washing liquid distribution element 50. At this time, since the movement of the washing liquid in the concave part 63 toward the outer peripheral side is due to a centrifugal force, the washing liquid is distributed substantially evenly to the plurality of grooves 67, and as a result, variations in the amount of washing liquid supplied to each test tube 80 can be reduced.

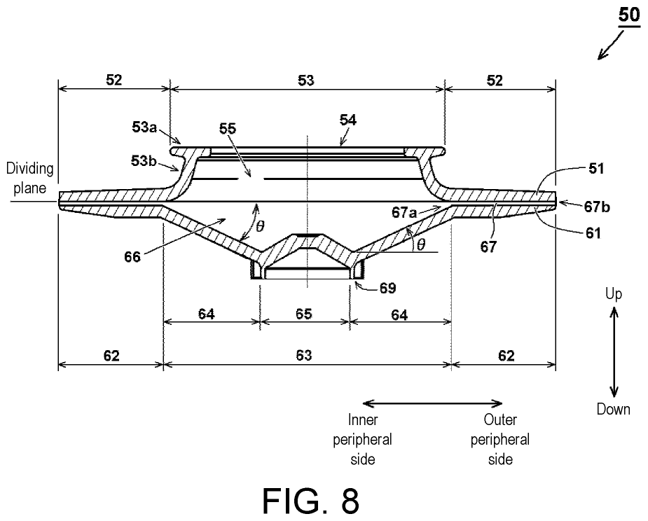

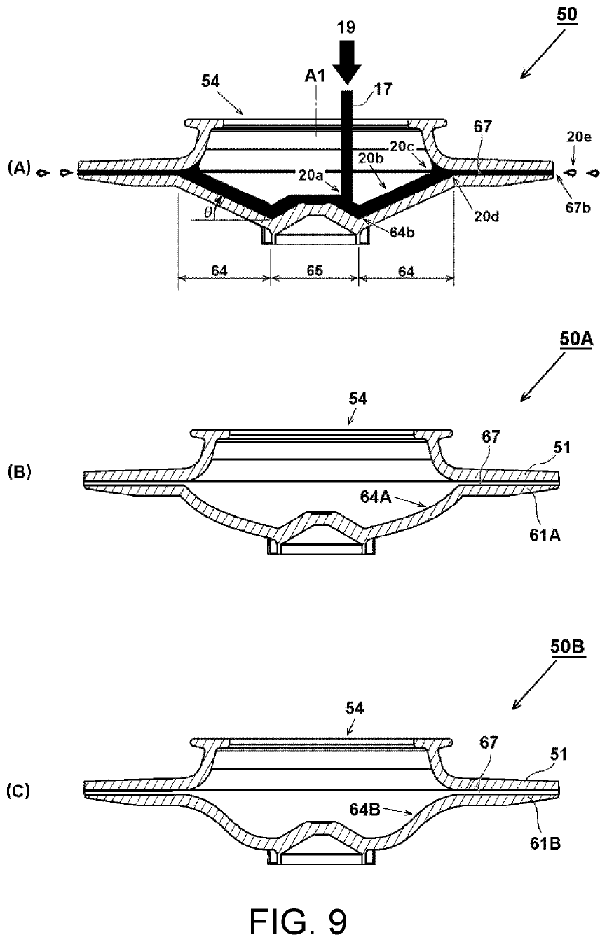

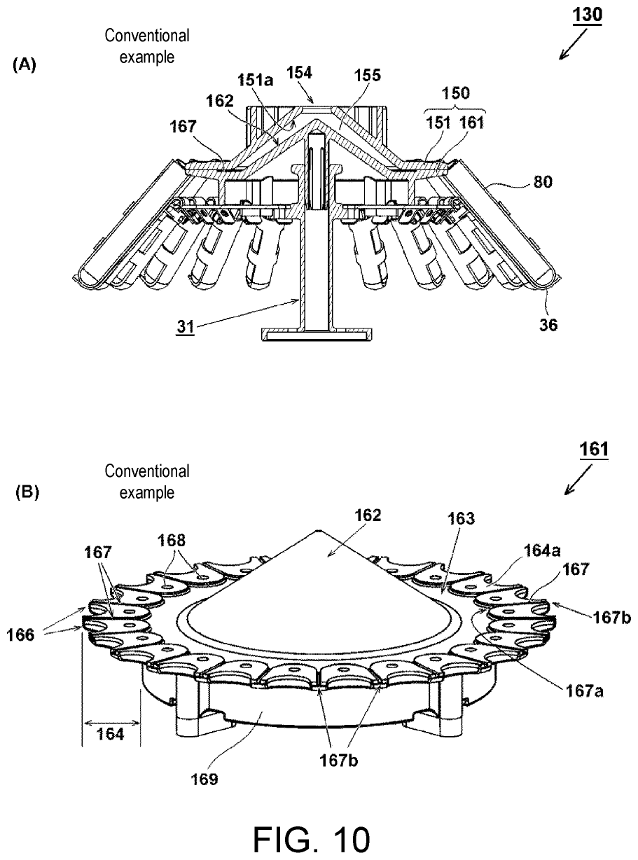

FIG. 8 is a vertical cross-sectional view showing a detailed shape of the washing liquid distribution element 50 of this embodiment. The upper distribution element 51 includes the washing liquid introduction part 53 positioned on the inner peripheral side and the upper annular part 52 positioned on the outer peripheral side. The lower surface of the upper annular part 52 (a portion opposed to the grooves 67) is formed to be flat. Being a portion that protrudes upward in a cylindrical shape, the washing liquid introduction part 53 includes the protruding neck part 53b and the flange part 53a formed above the neck part 53b, and the internal space 55 is formed on the inner side. The internal space 55 is a space for preventing overflow when the flow rate from the pump is larger than expected or when the amount of discharge from the discharge ports 67b is smaller than expected.

The lower distribution element 61 includes the concave part 63 positioned on the inner peripheral side and the lower annular part 62 positioned on the outer peripheral side. The concave part 63 includes the mountain-shaped axial center part 65 and the inclined part 64 formed between the axial center part 65 and the lower annular part 62. The inclined part 64 is a conical surface formed at an inclination angle θ with respect to the horizontal plane when viewed in a vertical cross section. Since the concave part 63 forms the internal space 66 of a predetermined size on the lower side of a dividing plane between the upper distribution element 51 and the lower distribution element 61, it is possible to store the washing liquid injected inside from the washing liquid introduction port 54 at the bottom of the concave part 63. The inlet 67a of the groove 67 is connected to the outer peripheral edge of the inclined part 64. The groove 67 extends from the inner peripheral edge to the outer peripheral edge of the lower annular part 62, and the washing liquid is discharged through the discharge port 67b. The axial center part 65 is formed of a flat surface or a curved surface having an inclination different from the inclined part 64, and an attachment part 69 is formed below the axial center part 65. The attachment part 69 is a portion for fixing to the flange part 32a of the rotor body 31. A screw boss (not shown) is formed at the attachment part 69, and the washing liquid distribution element 50 is fixed to the rotor body 31 by a plurality of screws (not shown).

(A) of FIG. 9 is a view showing injection of the washing liquid 17 into the washing liquid distribution element 50. Herein, in a state in which the rotor 30 is rotated at 1200 rpm (constant speed rotation), as the washing liquid 17 is discharged from the nozzle 19 as indicated by an arrow, it drops into the concave part 63. Herein, the washing liquid 17 is dropped onto the axial center part 65 slightly off the rotation axis A1 as indicated by an arrow 20a. Since the drop position indicated by the arrow 20a does not need to be strictly determined, it may be selectively within the axial center part 65 or in the vicinity of the inner peripheral edge of the inclined part 64. The washing liquid 17 that has dropped into the concave part 63 accumulates at the lowest bottom portion in the concave part 63, and then climbs the slope in the vicinity indicated by an arrow 20b due to the centrifugal force. Immediately after starting the supply of the washing liquid, since the amount of the washing liquid supplied from the nozzle 19 is larger than the amount of the washing liquid that climbs the inclined part 64 due to the centrifugal force, the washing liquid will temporarily accumulate on the lower side of the surface (i.e., bottom part 64b).

The washing liquid that has climbed the slope of the inclined part 64 as indicated by the arrow 20b stays in the vicinity of an arrow 20c at the outer edge of the slope, i.e., in the vicinity of the entrance of the groove 67 (vicinity of the inlet 67a). Since the washing liquid uniformly climbs the slope due to the centrifugal force, the centrifugal force applied to the staying washing liquid is also uniform. Further, the amount of the staying washing liquid is also uniform at all 24 positions, and as a result, the amount of the washing liquid 17 that flows into the groove 67 from the vicinity of an arrow 20d and is discharged from the discharge port 67b is uniform at the plurality of discharge ports 67b. In this manner, since the liquid pressure applied to the washing liquid 17 discharged from the washing liquid distribution element 50 is kept constant by effectively using the centrifugal force, the amount of the washing liquid discharged from the discharge port 67b can be evenly distributed to the plurality of test tubes, and the configuration can be made so that there is little variation.

The inclination angle θ of the inclined part 64 of this embodiment is 25° with respect to the rotation axis A1. If the angle of the slope 64a is increased, there would be drawbacks that it would be necessary to rotate the rotor 30 at high speed to supply the washing liquid from the discharge port 67b to the test tube 80, and also the size of the washing liquid distribution element 50 would increase in the up-down direction. Conversely, if the angle of inclination is decreased, there would be an advantage that the size of the washing liquid distribution element 50 could be small in the up-down direction and could be manufactured compactly, but there would be concern that the effect of the centrifugal force when the washing liquid moves to the outer peripheral side would be weakened, and the amount of the washing liquid branched into each of the plurality of flow paths (grooves 67) would vary. Therefore, to increase the strength of the rotor 30 as a whole, prevent an increase in the length of time for reaching the centrifugation process, and prevent an increase in the length of time of one cycle, the angle of the slope 64a is preferably set within the range of 15° to 45°, particularly preferably within the range of 25° to 35°.

As illustrated in (A) of FIG. 9, the washing liquid 17 supplied from the nozzle 19 (see FIG. 1) descends the slope of the axial center part 65 by the kinetic energy due to the momentum emitted from the nozzle 19 (see FIG. 1) and gravity, and after accumulating in the vicinity of the lowest bottom (vicinity of the arrow 64b) of the inclined part 64, the washing liquid 17 climbs the slope due to the centrifugal force and reaches the inlet 67a of the groove 67. In this manner, to exploit the principle that the washing liquid climbs the slope by centrifugal force, the vertical cross-sectional shape of the slope 64a passing through the rotation axis A1 does not necessarily need to be a straight line shape. For example, as shown in (B) of FIG. 9, it may be formed by a slope 64A having a downward arcuate cross section, or may be formed by a slope 64B having an upward arcuate shape. Further, in the case where the volume of the concave part 63 is relatively large with respect to the washing liquid to be injected, the concave part 63 may be provided with a slope only near the outer peripheral edge thereof, and the inner peripheral portion may be a horizontal or substantially horizontal bottom surface. Even if the shape of the lower distribution element is any of the shapes shown in (A) to (C) of FIG. 9 or a shape different from these shapes, the effects of the present invention can be obtained as long as the washing liquid rises through the slope by centrifugal force and, after rising, flows into the grooves 67 in a uniform amount at a uniform pressure. In the present invention, since the washing liquid 17 is supplied to the test tubes 80 using centrifugal force, an effect equivalent to that of a case provided with a centrifugal pump in the washing liquid distribution element 50 can be obtained.

Although the present invention has been described above based on the embodiments, the present invention is not limited to the above-described embodiments, and various modifications may be made within a range without departing from the gist thereof. For example, although the washing liquid distribution element 50 has been configured to be made of synthetic resin, the washing liquid distribution element 50 may also be made of any material, such as metal or other materials. Further, the grooves 67 may be formed by cutting based on machining instead of by injection molding of synthetic resin. Furthermore, the washing liquid distribution element 50 and the rotor body 31 may be configured to be detachable with one touch. Furthermore, the grooves 67 may be provided in both the upper and lower distribution elements.

### REFERENCE SIGNS LIST

1 . . . (Cell washing) centrifuge, 2 . . . Housing (frame), 2a . . . Base part (of housing), 3 . . . Chamber, 4 . . . Rotor chamber, 5 . . . Leg, 6 . . . Door, 6a . . . Hinge, 7 . . . Drain pipe, 7a . . . Discharge port, 8 . . . Motor, 9 . . . Drive shaft, 10 . . . Control device, 12 . . . Operation display panel, 13 . . . Post, 14 . . . Rubber damper, 15 . . . Bearing, 17 . . . Washing liquid, 17a . . . Supernatant, 18 . . . Washing liquid supply pipe, 19 . . . Nozzle, 30 . . . Rotor, 31 . . . Rotor body, 32a . . . Flange part, 32b . . . Main shaft part, 32c . . . Attachment part, 34 . . . Circular holding part, 35 . . . Turning shaft, 36 . . . Test tube holder, 36a, 36b . . . Holding insertion part, 36c . . . Holding bottom part, 36d . . . Stopper, 37 . . . Swing direction, 41 . . . Bottom surface part, 42 . . . Stopper, 43 . . . Holding means, 44 . . . Upper magnetic member, 44a . . . Attraction part, 45 . . . Lower magnetic member, 45a . . . Attraction part, 45b . . . Labyrinth part, 46 . . . Ring-shaped coil (magnetic coil), 50, 50A, 50B . . . Washing liquid distribution element, 51 . . . Upper distribution element, 52 . . . Upper annular part, 53 . . . Washing liquid introduction part, 53a . . . Flange part, 53b . . . Neck part, 54 . . . Washing liquid introduction port, 55 . . . Internal space, 56 . . . Screw hole, 61, 61A, 61B . . . Lower distribution element, 62 . . . Lower annular part, 62a . . . Flat surface, 63 . . . Concave part, 64, 64A, 64B . . . Inclined part (slope), 64a . . . Slope, 64b . . . Bottom part, 65 . . . Axial center part, 66 . . . Internal space, 67 . . . Groove (washing liquid passage), 67a . . . Inlet, 67b . . . Discharge port, 68 . . . Screw groove, 69 . . . Attachment part, 80 . . . Test tube, 80a . . . Opening, 90 . . . Washing liquid collection cover, 90a . . . Discharge part, 99 . . . Pump, 130 . . . Rotor, 150 . . . Washing liquid distribution element, 151 . . . Upper distribution element, 151a . . . Inner wall, 154 . . . Washing liquid introduction port, 155 . . . Internal space, 161 . . . Lower distribution element, 162 . . . Conical surface, 163 . . . Washing liquid receiving part, 164 . . . Lower annular part, 164a . . . Contact surface, 166 . . . Protruding part, 167 . . . Groove, 167a . . . Inlet, 167b . . . Injection port, 168 . . . Screw hole, 169 . . . Cylindrical part, A1 . . . Rotation axis (of rotor), B1 . . . Center axis (of test tube)

1. A centrifuge comprising:
a motor having a drive shaft;
a rotor body connected to the drive shaft of the motor and rotated by the motor;
a plurality of test tube holders mounted in a circular array to an outer peripheral side of the rotor body and supported to be capable of turning in an outer horizontal direction of the circular array by centrifugal force;
a washing liquid distribution element which is mounted to the rotor body and supplies a washing liquid into a plurality of test tubes respectively held by the plurality of test tube holders by discharging the washing liquid in a radial direction from a rotation center toward an outer periphery; and
a control device controlling the motor, wherein
the washing liquid distribution element comprises an upper distribution element and a lower distribution element,
the upper distribution element comprises a washing liquid introduction part having a washing liquid introduction port at a center, and an upper annular part continuous at a periphery of the washing liquid introduction part,
the lower distribution element comprises a concave part recessed in a direction away from a side on which the upper distribution element is positioned, and a lower annular part arranged at a position on a radially outer side of the concave part and opposed to the upper annular part,
a plurality of grooves in a radial pattern are formed in one of a lower surface of the upper annular part and an upper surface of the lower annular part, and flow paths through which the washing liquid is discharged from the washing liquid distribution element are formed by joining the grooves to the opposing annular part, and
an inclined part that rises as it goes from a central axis of rotation toward the radially outer side is formed at an outer edge of the concave part to supply the washing liquid to the flow paths by centrifugal force.

2. The centrifuge according to claim 1, wherein the concave part comprises the inclined part and an axial center part formed on an inner side of the inclined part, and
the inclined part occupies half or more of the concave part in the radial direction, and
the axial center part is formed of a flat surface or a curved surface having an inclination different from that of the inclined part.

3. The centrifuge according to claim 2, wherein the washing liquid introduction part comprises a neck part connected to an inner peripheral edge part of the upper annular part, and an annular part protruding from an upper edge part of the neck part toward one or both of a radially inner side and a radially outer side, and
the washing liquid introduction port is formed by the annular part.

4. The centrifuge according to claim 3, wherein the washing liquid introduction port is positioned higher than a dividing plane between the upper distribution element and the lower distribution element, and
the axial center part is positioned lower than the dividing plane between the upper distribution element and the lower distribution element.

5. The centrifuge according to claim 1, wherein a flange part is provided at an outer peripheral part of the washing liquid introduction port, and a diameter of the flange part is 80 mm or less.

6. The centrifuge according to claim 1, wherein the flow paths formed by joining the upper distribution element and the lower distribution element are arranged at equal intervals in a circumferential direction, and the lower surface of the upper distribution element and the upper surface of the lower distribution element are in close contact with each other at a portion other than the grooves when viewed in the circumferential direction, and
the upper distribution element and the lower distribution element are fixed by providing screw parts at each of the surfaces in close contact.

7. The centrifuge according to claim 6, wherein a width of the flow path when viewed in the circumferential direction is wide on an inner peripheral edge side of the lower distribution element, and has a cross section of the flow path that narrows as it goes toward the radially outer side.

8. The centrifuge according to claim 1, wherein the inclined part has a vertical cross-sectional shape that is a straight line shape, and has an inclination of 10 degrees to 45 degrees with respect to a horizontal plane.

9. The centrifuge according to claim 1, wherein the inclined part has a vertical cross-sectional shape that is a straight line shape, and has an inclination of 25 degrees to 35 degrees with respect to a horizontal plane.

10. The centrifuge according to claim 1, wherein the inclined part has a vertical cross-sectional shape that is an arcuate shape.

11. The centrifuge according to claim 10, wherein the washing liquid distribution element is fixed to the rotor body by screws.

12. The centrifuge according to claim 3, wherein an inner diameter of the annular part is 60 mm or more and 80 mm or less.

13. A rotor for a centrifuge, comprising:
the rotor body according to claim 1;
the plurality of test tube holders mounted in a circular array to the rotor body; and
the washing liquid distribution element mounted to the rotor body, wherein
the rotor body comprises a mounting part mounted to a drive shaft of a centrifuge and is configured to be detachable from the drive shaft.

14. The rotor for a centrifuge according to claim 13, comprising a holding means which holds the test tube at a vertical angle or at an angle close to the vertical angle by preventing turning of the test tube holder.
